(19) United States
(12) Patent Application Publication
(10) Pub. No.: US 2015/0259365 A1
(43) Pub. Date: Sep. 17, 2015

(54) PREPARATION METHOD OF VINYL-TERMINATED SILOXANE

(71) Applicant: NEW MATERIAL INSTITUTE OF SHANDONG ACADEMY OF SCIENCES, Jinan City, Shandong Province (CN)

(72) Inventors: Dan Peng, Jinan City (CN); Weibo Lv, Jinan City (CN); Qiuhong Mu, Jinan City (CN); Min Zhang, Jinan City (CN); Jinhui Li, Jinan City (CN)

(21) Appl. No.: 14/388,065

(22) PCT Filed: Aug. 15, 2013
(86) PCT No.: PCT/CN2013/000958

§ 371 Date: Sep. 25, 2014

(30) Foreign Application Priority Data
Jul. 24, 2013 (CN) 201310314762.4

(51) Int. Cl. C07F 7/18

(52) U.S. Cl. CPC C07F 7/1892; C07F 7/1808

(57) ABSTRACT

The invention relates to a preparation method of vinyl-terminated siloxane. R²R³Si(OR⁴)₂, R¹₂(CH₂═CH)SiOSi(CH═CH₂)R¹₂, an organic acid and a catalyst are added into a reaction bottle according to the molar ratio of 1:1-1.5:1-2.5:0.005-0.01, wherein R¹ is alkyl, R² and R³ are alkyl, aryl or substituted alkyl, substituted aryl identically and differently, and R⁴ is alkyl, heating is performed to 50-80° C. while stirring, the stirring reaction is performed at the temperature for 5-30 min, then a dehydrating agent is added, and the reaction is continuously performed for 2-5 h at the temperature of 50-80° C.; and the temperature is reduced to room temperature after the end of reaction, and then dilution, washing with water to neutral, collection of an organic phase, drying, filtering, concentration, reduced pressure distillation and collection of a fraction at corresponding pressure and temperature are sequentially performed so as to obtain a vinyl-terminated siloxane compound product.

### FIELD OF THE INVENTION

The invention relates to a preparation method of vinyl-terminated siloxane and belongs to the technical field of synthesis of organic silicon.

### BACKGROUND OF THE INVENTION

A vinyl-terminated siloxane compound, namely R₂¹(CH₂═CH)SiO(R²R³)SiOSi(CH═CH₂)R₂¹ is applicable to production of a series of products, including liquid silicone rubber, addition type silicone rubber, high-temperature rubber, raw rubber, silicone gel, vinyl silicone oil and the like because vinyl contained therein can participate in hydrosilylation reaction, thereby occupying an essential position in many rubber products and being an important industrial raw material. Particularly, in recent years, along with the development of organic silicon material for LED packaging, the vinyl-terminated siloxane compound containing phenyl can improve the refractive index of silica gel and reduce the viscosity, thereby having extensive application prospects.

In general, there are two methods for preparing the vinyl-terminated siloxane compound, one method is the method of performing cohydrolysis condensation on vinyl chlorosilane and R²R³SiCl₂; and the other method is the method of performing catalytic balance on a vinyl terminating agent and straight chain poly siloxane. Mixtures with different degrees of polymerization are often obtained through the two methods, wherein a trisiloxane compound, namely R¹₂(CH₂═CH)SiO(R²R³)SiOSi(CH═CH₂)R¹₂ is relatively for (less than 30%) in content and difficult to separate.

### SUMMARY OF THE INVENTION

The invention aims at providing a preparation method of vinyl-terminated siloxane for overcoming the above deficiencies. The method has the advantages of mild conditions and easiness in separation of a product.

A preparation method of vinyl-terminated siloxane comprises the following steps:

(1) Selecting raw materials R²R³Si(OR⁴)₂ and R¹₂(CH₂═CH)SiOSi(CH═CH₂)R¹₂, wherein R¹ is alkyl, R² and R³ are alkyl, aryl or substituted alkyl, substituted aryl identically and differently, and R⁴ is alkyl;

(2) Adding R²R³Si(OR⁴)₂, R¹₂(CH₂═CH)SiOSi(CH═CH₂)R¹₂, an organic acid and a catalyst into a reaction bottle according to the molar ratio of 1:1-1.5:1-2.5:0.005-0.01, heating to 50-80° C. while stirring, performing stirring reaction for 5-30 min at the temperature, adding a dehydrating agent, and continuously reacting for 2-5 h at the temperature of 50-80° C.; and

(3) Reducing the temperature to room temperature after the end of reaction, adding a non-polar organic solvent for dilution, washing with deionized water to neutral, collecting an organic phase, drying, filtering, concentrating, performing reduced pressure distillation on concentrate, and collecting a fraction at corresponding pressure and temperature so as to obtain a vinyl-terminated siloxane compound product.

The structure of the product is as follows:

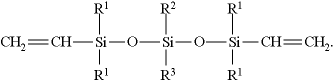

In the raw materials described in the step (1) in the preparation method, R¹ is preferably alkyl containing C₁₋₄, and further preferably methyl or ethyl; R² and R³ are preferably alkyl containing C₁₋₆ and aryl containing a benzene ring, and further preferably straight chain alkyl containing C₁₋₄, phenyl, benzyl and phenethyl; and R⁴ is preferably alkyl containing C₁₋₄, and further preferably methyl.

The adding amount of the dehydrating agent in the step (2) is 0.5-1.5 times the molar amount of R²R³Si(OR⁴)₂. The organic acid is formic acid, acetic acid or propionic acid. The catalyst is a strong acid catalyst and selected from one or more of hydrochloric acid. concentrated sulfuric acid, trifluoromethanesulfonic acid, strongly acidic ion-exchange resin and solid acid. The used dehydrating agent is concentrated sulfuric acid, acetic anhydride or N,N′-dicyclohexyl carbodiimide.

The non-polar organic solvent in the step (3) is benzene, toluene, xylene, n-hexane or n-heptane.

According to the invention, the organic acid is used for providing. protons, and an intermediate taking R²R³Si(OH)₂ as a main product is obtained by controlling the feed ratio of organic acid and R²R³Si(OR⁴)₂. The addition of the dehydrating agent can enable R²R³Si(OH)₂ and (CH₂═CH)SiOSi(CH═CH₂)R¹₂ to efficiently react under mild conditions so as to generate a trisiloxane compound, namely R¹₂(CH₂═CH)SiO(R²R³)SiOSi(CH═CH₂)R¹₂. Through the above two steps, compared with the prior art, the product purity and the yield of the invention are obviously improved.

The invention has the following beneficial effects:

(1) The process method has the advantages that the raw materials are low in cost and easy to obtain, the process conditions are mild, the process method is simple and convenient to operate and suitable for industrial production, and the production cost is low;

(2) The prepared product has the advantages that the product is relatively pure and easy to separate, and the yield can be above 50%; and the purity is high.

### BRIEF DESCRIPTION OF THE DRAWINGS

FIG. 1 is a spectrogram of the product ¹H NMR (CDCl₃) obtained according to specific embodiment 1 of the invention.

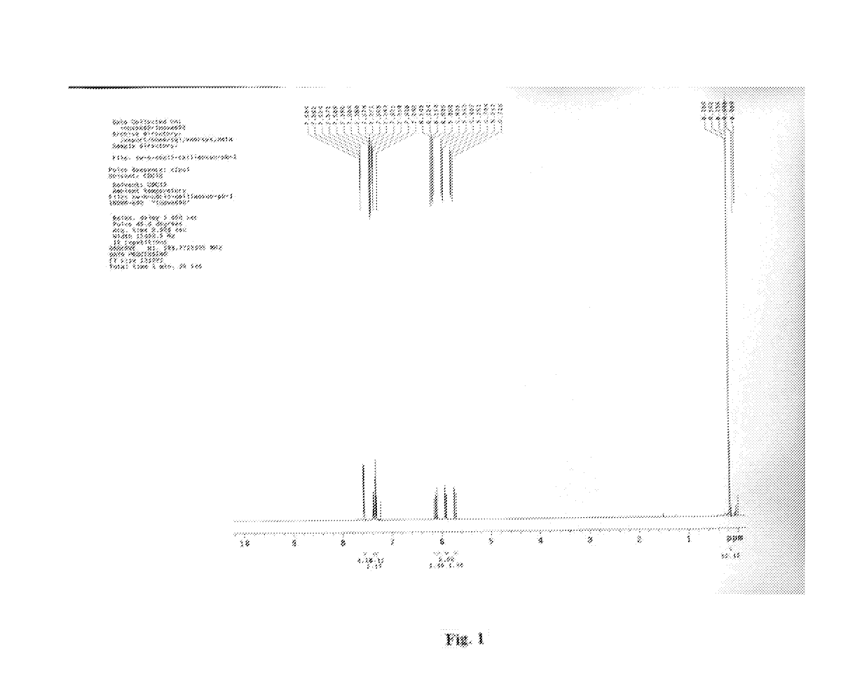

### DETAILED DESCRIPTION OF THE EMBODIMENTS

The invention is further described below with the combination of embodiments.

### Embodiment 1

A preparation method of (CH₃)₂(CH₂═CH)SiO(C₆H₅)₂SiOSi(CH═CH₂)(CH₃)₂;

Diphenyldimethoxysilane (61.09 g), trifluoromethanesulfonic acid (0.20 g), 1,3-divinyl-1,1,3,3-tetramethyldisiloxane (46.60 g) and acetic acid (37.81 g) are added into a four-neck round bottom flask, heated to 65° C. and reacted for 30 min, and then acetic anhydride (12.76 g) 6g) is added and continuously reacted for 2 h at the temperature of 65° C. The temperature is reduced to room temperature after the end of reaction, toluene is added for dilution, and washing with deionized water is performed to neutral. A toluene layer is collected, and anhydrous calcium chloride is added for drying. A drying agent is filtered out, and toluene is removed by concentrating filtrate. Reduced pressure distillation is performed on concentrate, and a fraction of 165-170° C./4 mmHg is collected, wherein the yield is 51.2%, and the purity is 99%. The structure of the product is proved to be δ (ppm): 0.156 (12H, —CH₃), 5.71-5.938 (4H, ═CH₂), 6.09-6.149 (2H, —CH═), 7.318-7.584 (10H, —C₆H₅) through a spectrogram of ¹H NMR (CDCl₃).

### Embodiment 2

A preparation method of (CH₃)₂ (CH₂═CH)SiO(C₆H₅)(CH₃)SiOSi(CH═CH₂)(CH₃)₂; Methylphenyldimethoxysilane (18.20 g), trifluoromethanesulfonic acid (0.10 g), 1,3-divinyl-1,1,3,3-tetramethyldisiloxane (18.64 g) and acetic acid (15.13 g) are added into a four-neck round bottom flask, heated to 70° C. and reacted for 30 min, and then acetic anhydride (5.10 g) is added and continuously reacted for 1 h at the temperature of 70° C. The temperature is reduced to room temperature after the end of reaction, toluene is added for dilution, and washing with deionized water is performed to neutral. A toluene layer is collected, and anhydrous calcium chloride is added for drying. A drying agent is filtered out, and toluene is removed by concentrating filtrate. Reduced pressure distillation is performed on concentrate, and a fraction of 115-120° C./5 mmHg is collected, wherein the yield is 54.0%, and the purity is 96%.

### Embodiment 3

A preparation method of (CH₃)₂(CH₂═CH)SiO(CH₃)₂SiOSi(CH═CH₂)(CH₃)₂; Dimethyldimethoxysilane (24.00 g), trifluoromethanesulfonic acid (0.20 g), 1,3-divinyl-1,1,3,3-tetramethyldisiloxane (37.21 g) and acetic acid (30.25 g) are added into a four-neck round bottom flask, heated to 50° C. and reacted for 30 min, and then acetic anhydride (10.21 g) is added and continuously reacted for 2 h at the temperature of 50° C. The temperature is reduced to room temperature after the end of reaction, toluene is added for dilution, and washing with deionized water is performed to neutral. A toluene layer is collected, and anhydrous calcium chloride is added for drying. A drying agent is filtered out, and toluene is removed by concentrating filtrate. Reduced pressure distillation is performed on concentrate, and a fraction of 77° C.-82° C./20 mmHg is collected, wherein the yield is 51.7%, and the purity is 98%.

The above embodiments are used for describing the preferred implementing schemes of the invention rather than limiting the protection scope of the invention. On the basis of the technical schemes of the invention, various modifications or variations, made by those of skilled in the art without creative efforts, are still within the protection scope of the invention.

1. A preparation method of vinyl-terminated siloxane, comprising the following steps:
(1) Selecting raw materials R²R³Si(OR⁴)₂ and R¹₂(CH₂═CH)SiOSi(CH═CH₂)R¹₂, wherein R¹ is alkyl, and R² and R³ are alkyl, aryl or substituted alkyl, substituted aryl identically and differently;
(2) Adding R²R³Si(OR⁴)₂, R¹₂(CH₂═CH)SiOSi(CH═CH₂)R¹₂, an organic acid and a catalyst into a reaction bottle according to the molar ratio of 1:1-1.5:1-2.5:0.005-0.01, heating to 50-80° C. while stirring, performing stirring reaction for 5-30 min at the temperature, adding a dehydrating agent, and continuously reacting for 2-5 h at the temperature of 50-80° C.; and
(3) Reducing the temperature to room temperature after the end of reaction, adding a non-polar organic solvent for dilution, washing with deionized water to neutral, collecting an organic phase, drying, filtering, concentrating, performing reduced pressure distillation on concentrate, and collecting a fraction at corresponding pressure and temperature so as to obtain a vinyl-terminated siloxane compound product.

2. The preparation method of vinyl-terminated siloxane according to claim 1, wherein the raw materials in the step (1), R¹ is alkyl containing C₁₋₄, R² and R³ are alkyl containing C₁₋₆ and aryl containing a benzene ring, and R⁴ is alkyl containing C₁₋₄.

3. The preparation method of vinyl-terminated siloxane according to claim 2, wherein the raw materials in the step (1), R¹ is methyl or ethyl; R² and R³ are selected from straight chain alkyl containing C₁₋₄, phenyl, benzyl or phenethyl, and R⁴ is alkyl.

4. The preparation method of vinyl-terminated siloxane according to claim 1, wherein the adding amount of the dehydrating agent in the step (2) is 0.5-1.5 times the molar amount of R²R³Si(OR⁴)₂.

5. The preparation method of vinyl-terminated siloxane according to claim 1, wherein the organic acid is formic acid, acetic acid or propionic acid.

6. The preparation method of vinyl-terminated siloxane according to claim 1, wherein the catalyst is a strong acid catalyst and selected from one or more of hydrochloric acid, concentrated sulfuric acid, trifluoromethanesulfonic acid, strongly acidic ion-exchange resin and solid acid.

7. The preparation method of vinyl-terminated siloxane according to claim 1, wherein the used dehydrating agent is concentrated sulfuric acid, acetic anhydride or N,N′-dicyclohexyl carbodiimide.

8. The preparation method of vinyl-terminated siloxane according to claim 1, wherein the non-polar organic solvent in the step (3) is benzene, toluene, xylene, n-hexane or n-heptane.
